(19) United States
(12) Patent Application Publication
(10) Pub. No.: US 2025/0017204 A1
(43) Pub. Date: Jan. 16, 2025

(54) METHOD OF PREPARING BIODEGRADABLE MICROCAPSULES BASED ON GELATINE

(71) Applicant: SYNGENTA CROP PROTECTION AG, Basel (CH)

(72) Inventors: Lewis Charles WILKINS, Greensboro, NC (US); Andrew James COUGHLIN, Greensboro, NC (US); Kelli Anne STOCKMAL, Greensboro, NC (US); Martine Ingrid DE HEER, Bracknell, Berkshire (GB); Matthew Joseph RYMARUK, Bracknell, Berkshire (GB); Emily Louise KYNASTON, Bracknell, Berkshire (GB); Catherine Paula WALLER, Bracknell, Berkshire (GB)

(73) Assignee: SYNGENTA CROP PROTECTION AG, Basel (CH)

(21) Appl. No.: 18/713,364

(22) PCT Filed: Nov. 16, 2022
(86) PCT No.: PCT/EP2022/082139

§ 371 Date: May 24, 2024

Related U.S. Application Data
(60) Provisional application No. 63/283,644, filed on Nov. 29, 2021.

(51) Int. Cl. A01N 25/28; A01N 25/10; A01N 53/00; A01P 7/04

(52) U.S. Cl. CPC A01N 25/28; A01N 25/10; A01N 53/00; A01P 7/04

(57) ABSTRACT

A method of encapsulating an agrochemical in a biodegradable capsule comprising the complex coacervation of gelatin and a carboxylated polysaccharide.

The present invention relates to a method of preparing biodegradable microcapsules and the uses of the prepared microcapsules.

Microencapsulation is known in many fields of technology. In the agrochemical field, microencapsulation can be beneficial for example for controlling the rate of release of the active ingredient, to ensure chemical stability of the active ingredient, and/or to protect the operators from exposure to the active ingredients.

The commonly employed process for preparing microcapsules in the agrochemical field is the use of oil-soluble monomers selected from diisocyanates and polyisocyanates, and then react these with water or with water-soluble diamines and polyamines at the oil-water interface of oil-water emulsions. This leads then to the formation of polyurea capsule walls. Such encapsulation technology in the formulation of agrochemical active ingredients is well known to those skilled in the art (see, for example, P. J. Mulqueen in “Chemistry and Technology of Agrochemical Formulations”, D. A. Knowles, editor, Kluwer Academic Publishers, 1998, pages 132-147).

Sustainability of agrochemical formulations and development of products with a low environmental impact has become an important target in the agrochemical field. As such, the biodegradability of microplastics has become an important topic and polyurea based microcapsules as used in many agrochemical formulations are not biodegradable. Hence, there is a need to provide new processes for preparing biodegradable encapsulated agrochemicals.

There is therefore provided a method of encapsulating an agrochemical in a biodegradable capsule comprising the complex coacervation of gelatin and a carboxylated polysaccharide.

This method results in capsules that demonstrate biodegradable behaviour while still offering enhanced active ingredient chemical/physical stability, together with a reduction in grower exposure to any active ingredient.

The term “biodegradable” is defined as meaning a compound which passes the OECD Guidelines for the Testing of Chemicals, test no. 301 (OECD 301 test). In particular, a compound which is “biodegradable” is defined as a compound which demonstrates at least 30%, preferably more than 40%, more preferably more than 50% and most preferably more than 60% mineralisation measured as evolved CO₂ or consumed O₂ in 28 days, wherein the mineralisation is measured according to test methods OECD TG 301 B, C, D, F or OECD TG 310.

‘Carboxylated polysaccharide’ includes both polysaccharides that naturally contain carboxylic acid groups and those that have been chemically modified to contain the same.

The noun “agrochemical” and term “agrochemically active ingredient” are used herein interchangeably, and include herbicides, insecticides, nematicides, molluscicides, fungicides, plant growth regulators and safeners; preferably herbicides, insecticides and fungicides.

“Complex coacervation” itself is defined as the complexation between two oppositely charged polyelectrolytes.

### First Embodiment

In a first embodiment the method advantageously comprises the three sequential steps of:
1) forming an emulsion of an aqueous phase comprising gelatin and an oil phase comprising the agrochemical;
2) adding the carboxylated polysaccharide; and
3) adding a crosslinker.

### Step (1)

The formation of the emulsion in step (1) may be effected by high-shear homogenisation. Step (1) may be carried out at a temperature of from 30 to 55° C.

Step (1) is carried out at a pH of from 4.5 to 7.5, such as from 5 to 7, or even from 5.6 to 6.3.

Optionally, antifoam and/or emulsifiers can be added at this stage. The antifoam may be present in an amount of from 0.05 to 0.2% by weight. The emulsifiers may be present in an amount of from 0.01 to 0.2% by weight.

The gelatin may be either Type A or Type B, preferably Type B. The gelatin may be present in an amount of from 1 to 6% by weight of the aqueous phase. A higher concentration of gelatin in step (1) has been found to lead to a smaller emulsion droplet size and thus a smaller ultimate coacervate capsule. Therefore, it is preferred for the gelatin to be present in the aqueous phase in an amount of from 2 to 6% by weight, such as from 3 to 6% by weight, from 4 to 6% by weight, or even from 4.5 to 5.8% by weight.

The oil phase may comprise a suitable hydrophobic solvent. By ‘suitable hydrophobic solvent’, we mean one with negligible water solubility, i.e., lower than 5 g/L, such as lower than 4 g/L, lower than 3 g/L, preferably lower than 1 g/L. Examples include, but are not limited to, alkyl benzoates, seed oils, alkylated seed oils and aromatic fluids.

The concentration of agrochemical in the oil phase is preferably from 1 to 100% by weight, such as from 5 to 99% by weight, from 10 to 75% by weight, from 20 to 70% by weight, from 30 to 65% by weight, from 40 to 60% by weight, preferably from 45 to 55% by weight. Advantageously, the concentration is greater than 45% by weight.

Preferably, the agrochemical is present in an amount of from 0.01 to 65% by weight of the final formulation such as from 1 to 59% by weight, from 2 to 58% by weight, from 5 to 55% by weight, from 10 to 20% by weight, 40 to 60% by weight or from 45 to 55% by weight.

### Step (2)

Step (2) preferably comprises the addition of carboxylated polysaccharide as an aqueous solution. Step (2) may be carried out at a temperature of from 30 to 55° C.

The carboxylated polysaccharide is preferably selected from one or more of gum arabic, sodium alginate, and carboxymethyl cellulose; and derivatives thereof.

Preferably only one carboxylated polysaccharide is used. In comparison to method employing two or more carboxylated polysaccharides this requires much less material to achieve the same or smaller capsule diameters and simplifies the method.

The ratio of gelatin to carboxylated polysaccharide is preferably from 4:1 to 1:4, such as from 3:1 to 1:3, most preferably from 2:1 to 1:2, such as 1:1. Working within these ratios has been found to reduce flocculation.

Step (2) may also advantageously comprise a high-shear homogenisation step after the addition of the carboxylated polysaccharide. An additional high-shear homogenisation step at this stage has surprisingly been found to aid in reducing the droplet diameter.

Step (2) may be carried out under acidic conditions. Advantageously, the pH of the emulsion is reduced to between 3 to 6.5, such as from 3 to 5, or even from 3.2 to 4.2, after the addition of the carboxylated polysaccharide. The change is pH is effected with an acid, such as acetic acid, citric acid, or hydrochloric acid and serves to induce complex coacervation.

Preferably, the temperature of the emulsion is reduced gradually to 15° C. or below, such as 12° C. or below, such as from 5 to 11° C., in order to harden the capsules.

The carboxylated polysaccharide is preferably present in an amount of from 0.25 to 3% by weight of the final formulation.

### Step (3)

The addition of a crosslinker improves the robustness and stability of the resulting capsule and thus their tolerance towards changes in pH, temperature, ionic strength (of combinations thereof) and the addition of co-formulants.

Cross-linking may occur through either covalent bonds and/or ‘physical’ cross-linking via secondary interactions, such as hydrogen bonding.

The crosslinker is preferably selected from polyaldehydes (such as glutaraldehyde), polyacids (such as citric acid), carbodiimides (such as 1-ethyl-3-(3-dimethylaminopropyl) carbodiimide), polyphenolic compounds (such as tannic acid), and aldose sugars.

The crosslinker is present in an amount of from 0.0001 to 2% by weight of the final formulation.

Dispersants may be added during step (3). Possible dispersants include lignosulfonates (e.g., Vanisperse CB, Ultrazine NA, or Reax 80D), polymeric dispersants (e.g., Morwet D425), and/or surfactants.

After step (3), the composition may be allowed to warm to ambient temperatures or actively warmed to a temperature of from 40 to 50° C. in order to enhance cross-linking.

### Second Embodiment

In a second embodiment, there is provided a method comprising the steps of:
1) forming an emulsion of an aqueous phase comprising gelatin and a carboxylated polysaccharide, and an oil phase comprising an agrochemical; and
2) adding a crosslinker.

The second embodiment requires a reduced number of steps relative to the first embodiment and thus has the according time efficiencies. It has also been found that the second embodiment typically results in a smaller capsules.

### Step (1)

The formation of the emulsion in step (1) may be effected by high-shear homogenisation. Step (1) may be carried out at a temperature of from 30 to 55° C.

Step (1) may be carried out at a pH of from 4 to 7.5, such as from 5 to 7, or even from 5.6 to 6.3.

Optionally, antifoam and/or emulsifiers can be added at this stage. The antifoam may be present in an amount of from 0.05 to 0.2% by weight. The emulsifiers may be present in an amount of from 0.01 to 0.2% by weight.

The gelatin may be either Type A or Type B, preferably Type B. The gelatin may be present in an amount of from 1 to 6% by weight of the aqueous phase. A higher concentration of gelatin in step (1) has been found to lead to a smaller emulsion droplet size and thus a smaller ultimate coacervate capsule. Therefore, it is preferred for the gelatin to be present in the aqueous phase in an amount of from 2 to 6% by weight, such as from 3 to 6% by weight, from 4 to 6% by weight, or even from 4.5 to 5.8% by weight.

The carboxylated polysaccharide is preferably selected from one or more of gum arabic, sodium alginate, and carboxymethyl cellulose; and derivatives thereof.

Preferably only one carboxylated polysaccharide is used as this requires much less material to achieve the same or smaller capsule diameters and simplifies the process.

The ratio of gelatin to carboxylated polysaccharide is preferably from 4:1 to 1:4, such as from 3:1 to 1:3, most preferably from 2:1 to 1:2, such as 1:1. Advantageously, working within these ratios has been found to reduce flocculation.

The oil phase may comprise a suitable hydrophobic solvent. By ‘suitable hydrophobic solvent’, we mean one with negligible water solubility, i.e., lower than 5 g/L, such as lower than 4 g/L, lower than 3 g/L, preferably lower than 1 g/L. Examples include, but are not limited to, alkyl benzoates, seed oils, alkylated seed oils and aromatic fluids.

The concentration of agrochemical in the oil phase is preferably from 1 to 100% by weight, such as from 5 to 99% by weight, from 10 to 75% by weight, from 20 to 70% by weight, from 30 to 65% by weight, from 40 to 60% by weight, preferably from 45 to 55% by weight. Advantageously, the concentration is greater than 45% by weight.

Preferably, the agrochemical is present in an amount of from 0.01 to 65% by weight of the final formulation such as from 1 to 59% by weight, from 2 to 58% by weight, from 5 to 55% by weight, from 10 to 20% by weight, 40 to 60% by weight or from 45 to 55% by weight.

### Step (2)

The addition of a crosslinker improves the robustness and stability of the resulting capsule and thus their tolerance towards changes in pH, temperature, ionic strength (of combinations thereof) and the addition of co-formulants.

Cross-linking may occur through either covalent bonds and/or ‘physical’ cross-linking via secondary interactions, such as hydrogen bonding.

Step (2) may be carried out under acidic conditions. Advantageously, the pH of the emulsion is reduced to between 3 to 6.5, such as from 3 to 5, or even from 3.2 to 4.2, prior to the addition of the crosslinker. The change is pH is effected with an acid, such as acetic acid, citric acid, or hydrochloric acid and serves to induce complex coacervation.

The crosslinker is preferably selected from polyaldehydes (such as glutaraldehyde), polyacids (such as citric acid), carbodiimides (such as 1-ethyl-3-(3-dimethylaminopropyl) carbodiimide), polyphenolic compounds (such as tannic acid), and aldose sugars.

The crosslinker is present in an amount of from 0.0001 to 2% by weight of the final formulation.

Dispersants may be added during step (2). Possible dispersants include lignosulfonates (e.g., Vanisperse CB, Ultrazine NA, or Reax 80D), polymeric dispersants (e.g., Morwet D425), and/or surfactants.

After step (2), the composition may be allowed to warm to ambient temperatures or actively warmed to a temperature of from 40 to 50° C. in order to enhance cross-linking.

### Microcapsules

The chemical nature of the agrochemical to be encapsulated is important when attempting encapsulation, in particular with regard to achieving delayed release. The agrochemical is advantageously hydrophobic. Without wishing to be bound by theory, it is believed that the hydrophilic and hydrated coacervate capsule wall thus provides a barrier to hydrophobic agrochemicals, resulting in very slow diffusion. Advantageously, the agrochemical has a solubility of from 0.001 to 200 mg/L, such as from 0.002 to 100 mg/L, from 0.002 to 50 mg/L, preferably from 0.002 to 20 mg/L or even from 0.002 to 1 mg/L. The agrochemical may be Lambda-cyhalothrin, prosulfocarb and/or tefluthrin.

Preferably the prepared capsules exhibit controlled release. ‘Controlled release’ includes any non-immediate release over a period of time and thus encompasses extended release, delayed release and triggered release (e.g., by capsule breakage on drydown).

Advantageously, the process does not comprise an additional emulsifier. The use of gelatin as the sole emulsifier avoids the requirement of having an additional emulsifier present, as the addition of additional emulsifiers (e.g. sodium dodecylsulfate or poly(vinyl alcohol) has been found to increase the flocculation of the capsules.

Advantageously, the prepared capsules have a diameter (D₅₀) of less than 15 microns, such as less than 14 microns, less than 10 microns, less than 9 microns, less than 8 microns, or even less than 7 microns. Preferably the capsules have a diameter of from 1 to 6 microns, such as from 2 to 5 microns.

There is thus provided a composition comprising a microcapsule prepared by the method described herein. There is provided the use of such a composition in the treatment of weeds, pests, nematodes, molluscs and/or fungi.

The prepared composition may be subsequently diluted. In which case, the agrochemical may be present in an amount of from 0.01 to 45% by weight of the final formulation such as from 0.1 to 30% by weight, from 0.5 to 20% by weight, from 0.6 to 15% by weight, or from 1 to 10% by weight.

There is also provided the use of a biodegradable microcapsule prepared by the method as described herein and the use of a biodegradable microcapsule for the controlled release of lambda-cyhalothrin and/or tefluthrin.

The invention is demonstrated in the following non-limiting Examples.

### Examples

### Compositions

A range of capsules were prepared according to the first embodiment the invention. The compositions are shown in Table 1.

TABLE 1

| | | Example | | | | | | | | | | |
|---|---|---|---|---|---|---|---|---|---|---|---|---|
| Step | Component (g) | A | B | C | D | E | F | G | H | I | J | K |
| 1)Emulsification | Gelatin | 1 | 2 | 1 | 2 | 1.5 | 1.2 | 1.5 | 1.5 | 1 | 0.44 | 0.44 |
| | Lambda- | 30 | 30 | 30 | 30 | 15 | 15 | 15 | 15 | 30 | 0 | 0 |
| | cyhalothrin | | | | | | | | | | | |
| | S-Metolachlor | 0 | 0 | 0 | 0 | 0 | 0 | 0 | 0 | 0 | 10.1 | 10 |
| | Solvent | 30 | 30 | 30 | 30 | 15 | 15 | 15 | 15 | 30 | 0.5 | 0.5 |
| | Antifoam | 0 | 0.2 | 0 | 0.2 | 0.1 | 0.1 | 0.1 | 0.1 | 0 | 0 | 0 |
| | DI water | 84 | 84 | 84 | 84 | 30.9 | 52.8 | 30.9 | 29.9 | 89 | 43.8 | 43.7 |
| | Emulsifier | 0 | 0.1 | 0 | 0 | 0 | 0.06 | 0 | 0 | 0 | 0.01 | 0.01 |
| 2)Complex | Gum Arabic | 1 | 1 | 0 | 0 | 0 | 0 | 0 | 0 | 1 | 0.44 | 0 |
| coacervation | Sodium | 0 | 0 | 1 | 1 | 0 | 0 | 0 | 0 | 0 | 0 | 0.44 |
| | Alginate | | | | | | | | | | | |
| | Sodium CMC | 0 | 0 | 0 | 0 | 0.75 | 0.6 | 0.75 | 0.75 | 0 | 0 | 0 |
| | DI water | 49 | 49 | 49 | 49 | 37.5 | 15.2 | 37.5 | 38.2 | 49 | 43.7 | 43.9 |
| 3)Crosslinking | Glutaraldehyde | 0 | 0.3 | 0.2 | 0.3 | 0.25 | 0.25 | 0 | 0 | 0.2 | 1 | 1 |
| | Tannic acid | 0.5 | 0 | 0 | 0 | 0 | 0 | 0.25 | 0 | 0 | 0 | 0 |
| | Fructose | 0 | 0 | 0 | 0 | 0 | 0 | 0 | 0.5 | 0 | 0 | 0 |

A capsules according to the second embodiment of the invention was prepared with the composition as per Table 2.

TABLE 2

| Component (g) | L |
|---|---|
| Gelatin | 1.25 |
| Lambda-cyhalothrin | 20 |
| S-Metolachlor | 0 |
| Solvent | 20 |
| Antifoam | 0.2 |
| DI water | 58 |
| Emulsifier | 0 |
| Sodium CMC | 0.625 |
| Gum Arabic | 0 |
| Sodium Alginate | 0 |
| Sodium CMC | 0 |
| DI water | 0 |
| Glutaraldehyde | 0.1 |
| Tannic acid | 0 |
| Fructose | 0 |

### FIGURES

FIG. 1: Crosslinked gelatin-NaCMC capsules (Composition E) in (a) dilute solution and (b) four days on drydown. Non-crosslinked capsules in (c) dilute solution and (d) immediate drydown. Scale bars=20 μm.

FIG. 2: Laser diffraction data recorded for both crosslinked capsules (Composition E, blue solid line) and non-crosslinked capsules (red dashed line).

FIGS. 3 and 4: Cryo-SEM images of non-crosslinked (left) and crosslinked (Composition E, right) gelatin/NaCMC capsules containing Lambda-cyhalothrin/Solvesso 200ND mixture as the encapsulated core.

FIG. 5: (a) Laser diffraction data recorded for gelatin/sodium alginate coacervate capsules, prepared using 2:1 ratio of gelatin:sodium alginate and 30% by weight oil phase. (b) Optical micrograph of the same capsules in the dilute state. (c) Optical micrograph of the same capsules after drying for 2 h.

FIG. 6: (a) Capsule size distribution obtained for a sample of gelatin/gum Arabic coacervate capsules. The gelatin:gum Arabic ratio was fixed at 1, the total polymer concentration was fixed at 2%, the oil phase comprised 50% by weight lambda-cyhalothrin and 50% by weight Solvesso 200 ND. (b) Optical micrograph of the capsules shown diluted to 0.1% by weight in water. (b) Optical micrograph of the capsules shown in (b) after drying for 16 h.

FIG. 7: Optical micrographs obtained for gelatin/gum Arabic capsules (composition I) before elevated-temperature storage. (a) non-crosslinked capsules in the wet state, (b) crosslinked capsules in the wet state, (c) non-crosslinked capsules in the dry state and (d) crosslinked capsules in the dry state. Scale bars correspond to 100 μm in all cases.

FIG. 8: Release of lambda-cyhalothrin from crosslinked gelatin/NaCMC as a function of capsule size over a period of 24 hours.

FIG. 9: Release of S-metolachlor from crosslinked gelatin/gum Arabic and crosslinked gelatin/alginate capsules over a period of 90 minutes.

FIG. 10: Laser diffraction data recorded for gelatin/sodium CMC coacervate capsules (composition L), prepared via embodiment 2 using 2:1 ratio of gelatin:sodium CMC and 40% by weight oil phase.

### ANALYSIS

### Composition E—Gelatin/Sodium Carboxymethyl Cellulose Coacervate Microcapsules

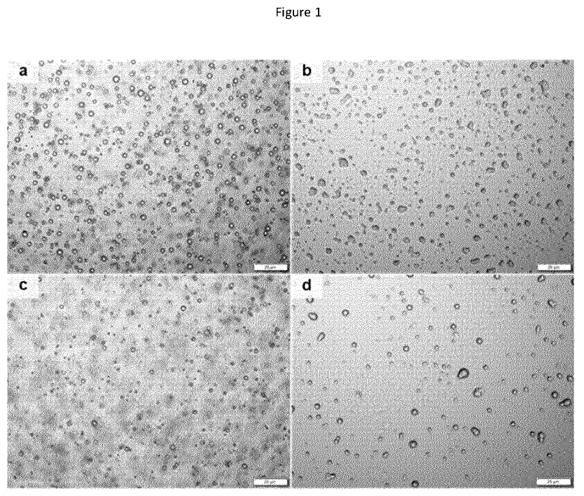

Coacervate microcapsules prepared using gelatin and sodium carboxymethyl cellulose are shown in FIG. 1. These capsules were prepared using a 2:1 ratio of gelatin:sodium carboxymethyl cellulose, a total polymer concentration of 2.25% by weight, and were crosslinked using 0.25 g of glutaraldehyde.

Optical microscopy indicated a spherical morphology for the capsules before and after crosslinking (FIGS. 1a & 1c, respectively). Moreover, both the non-crosslinked and crosslinked capsules retained their morphology on dry down (FIGS. 1b & 1d, respectively).

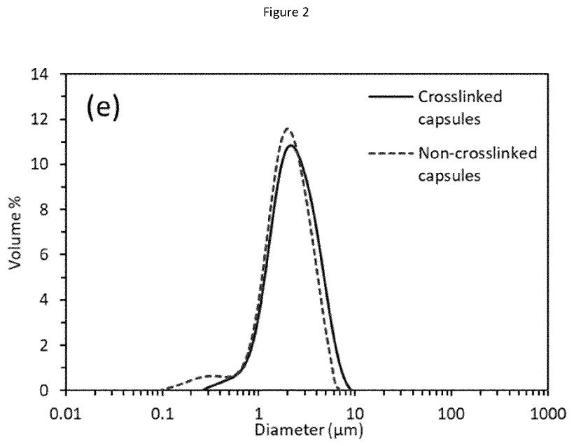

Laser diffraction indicated these capsules were well dispersed with no flocculation, with a volume-average diameter (D [4,3]) of 2.6 μm, Dv50=2.3 μm, and Dv95=5.3 μm. The non-crosslinked samples were characterized as having a D[4.3]=2.6 μm, Dv50=2.0 μm, and Dv95=4.6 μm (FIG. 2).

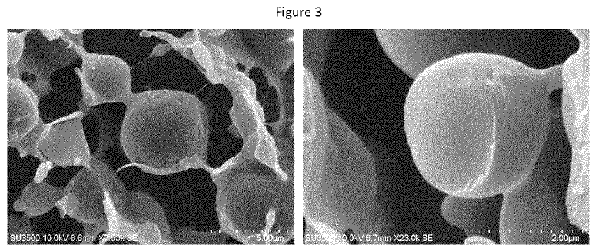

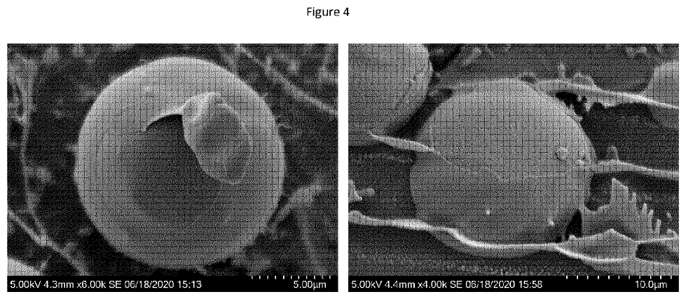

The structure of the non-crosslinked and crosslinked capsules was further characterized by cryo-SEM, where a thin yet continuous coacervate complex wall was observed around each capsule (FIGS. 3 and 4).

The release properties of the crosslinked gelatin/NaCMC capsules were characterised using a method based on the Collaborative International Pesticides Analytical Council (CIPAC) method ‘MT 190-Determination of release properties of lambda-cyhalothrin cs formulations’. In this method an aliquot of formulation containing 75 mg lambda-cyhalothrin was diluted with water to 6.0 g. Internal standard solution (standard hexane solution with ethanol removed) was added to the solution and set on a roller, where 1 mL aliquots were removed from the internal standard solution for sampling. A drop of trifluoroacetic acid was added to the vials before capping for GC analysis.

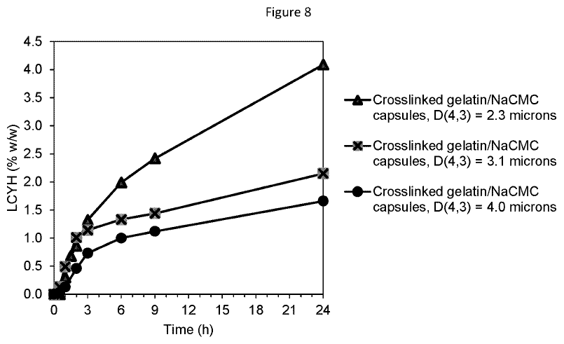

The capsules were shown to release lambda-cyhalothrin slowly over a period of 24 hours. However, it was also show that, for formulations of the same composition, variation in capsule size affect the level of controlled release. As shown in FIG. 8, smaller capsules released more lambda-cyhalothrin than larger capsules over the 24-hour time period.

### Composition D—Gelatin/Sodium Alginate Coacervate Microcapsules

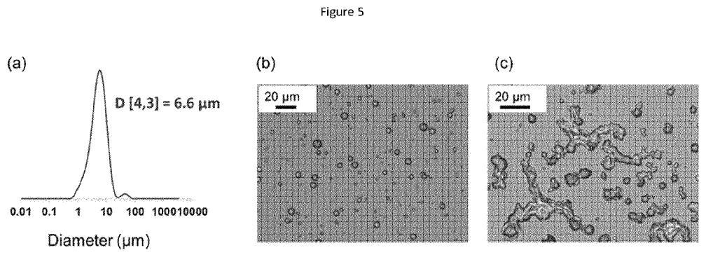

A representative example of coacervate microcapsules prepared using gelatin and sodium alginate is shown in FIG. 5. These capsules were prepared using a 2:1 ratio of gelatin:sodium alginate, a total polymer concentration of 1.5% by weight, and were crosslinked using 0.3 g of glutaraldehyde. Laser diffraction indicated that the resulting capsules had a D[4,3] of 6.6 μm (FIG. 5a). Optical microscopy indicated a well-defined spherical morphology for the dilute dispersion (FIG. 5b). Moreover, these capsules retained their structure on drying for 2 h (FIG. 5c).

### Composition I—Gelatin/Gum Arabic Coacervate Microcapsules

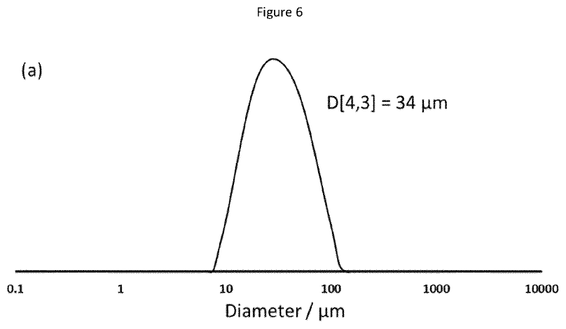

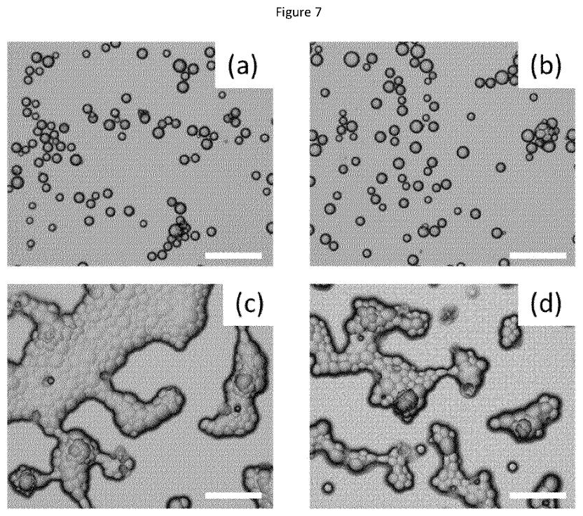

A representative example of coacervate microcapsules prepared using gelatin and gum Arabic is shown in FIGS. 6 and 7. These capsules were prepared using a 1:1 ratio of gelatin:gum arabic, a total polymer concentration of 1% by weight, and were crosslinked using 0.2 g of glutaraldehyde. Laser diffraction indicated that the resulting capsules had a D[4,3] of 34 μm (FIG. 6).

Optical microscopy indicated a well-defined spherical morphology for the dilute dispersion (FIG. 7b). Moreover, these capsules retained their structure on drying for 16 h (FIG. 7d). It can also be seen that non-crosslinked capsules (FIGS. 7a and 7c) do not demonstrate the same stability of structure during the same process.

Compositions J and K—Gelatin/Gum Arabic and Gelatin/Alginate Capsules with S-MOC

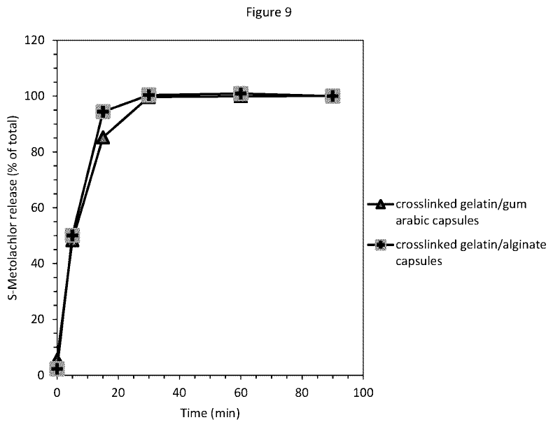

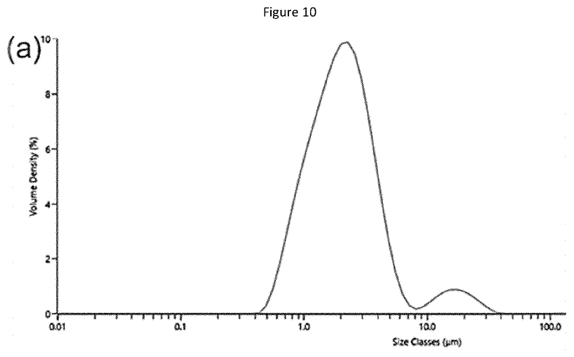

S-MOC was encapsulated by the described process with both gum Arabic and alginate to form Compositions J and K, respectively, and without the additional high-shear homogenisation step in step 2. The capsules were shown to release S-metolachlor quickly over a period of 90 hours (FIG. 9) and in contrast to the hydrophobic agrochemicals discussed above. The process was as described for Composition E.

### Biodegradation

Example B was tested for biodegradability via the OECD 301F test.

To perform such testing, the hydrophobic core material was first extracted from the capsules such that the residual core material comprised no more than 10% by weight of the capsules, and more preferably less than 5% of the capsules. The resulting isolated wall material was then resuspended in water prior to OECD 301 testing.

It was found that such capsules achieved 68% mineralisation within 28 days (data averaged over duplicate analyses).

The claimed process therefore results in the preparation of stable, yet biodegradable, microcapsules for an agrochemical.

The invention is defined by the claims.

1. A method of encapsulating an agrochemical in a biodegradable capsule comprising the complex coacervation of gelatin and a carboxylated polysaccharide, wherein the method comprises:
(1) forming an emulsion of an aqueous phase comprising gelatin and an oil phase comprising the agrochemical;
(2) adding the carboxylated polysaccharide; and
(3) adding a crosslinker, and
wherein the process does not comprise an additional emulsifier.

2. (canceled)

3. A method according to claim 1, wherein step (2) comprises the addition of carboxylated polysaccharide as an aqueous solution and/or is carried out under acidic conditions.

4. A method according to claim 1, wherein step (2) comprises a high-shear homogenisation step after the addition of the carboxylated polysaccharide.

5. A method according to claim 1, wherein step (3) comprises the addition of a dispersant.

6. A method of encapsulating an agrochemical in a biodegradable capsule comprising the steps of:
(1) forming an emulsion of an aqueous phase comprising gelatin and a carboxylated polysaccharide, and an oil phase comprising an agrochemical; and
(2) adding a crosslinker,
wherein the ratio of gelatin to carboxylated polysaccharide is from 4:1 to 1:4.

7. A method according to claim 1, wherein the crosslinker is selected from polyaldehydes, polyacids, polyphenols, aldose sugars.

8. A method according to claim 1, wherein the gelatin is present in an amount of from 1 to 6% by weight of the final formulation.

9. A method according to claim 1, wherein the carboxylated polysaccharide is present in an amount of from 0.25 to 3% by weight of the final formulation.

10. A method according to claim 1, wherein the crosslinker is present in an amount of from 0.0001 to 2% by weight of the final formulation.

11. A method according to claim 1, wherein the agrochemical is present in an amount of from 0.01 to 60% by weight of the final formulation;
and/or wherein
the agrochemical has a solubility of 0.001 to 200 mg/L, preferably wherein the agrochemical is lambda-cyhalothrin and/or tefluthrin.

12. (canceled)

13. A method according to claim 1, wherein the carboxylated polysaccharide is selected from one or more of gum Arabic, sodium alginate, and carboxymethyl cellulose, preferably only one carboxylated polysaccharide is used.

14. (canceled)

15. A method according claim 1, wherein the capsules have a diameter of less than 15 microns, preferably less than 10 microns, more preferably less than 5 microns; and/or exhibit controlled release.

16. A composition comprising a microcapsule prepared by the method of claim 1.

17. Use of a composition according to claim 13 in the treatment of weeds, pests, nematodes, molluscs and/or fungi.

18. Use of a biodegradable microcapsule prepared by the method of claim 1 for the delayed release of lambda-cyhalothrin and/or tefluthrin.

19. (canceled)
